(19) United States
(12) Patent Application Publication
(10) Pub. No.: US 2025/0239276 A1
(43) Pub. Date: Jul. 24, 2025

(54) Integrated System for Multimodal Media Review and Selective Content Redaction

(71) Applicant: Open Text Technologies, India Private Limited, Hyderabad (IN)

(72) Inventors: Sreedevi Balaji, Secunderabad (IN); Mutyala Vamsi Krishna, Hyderabad (IN); Arun Kumar Makloor, Hyderabad (IN)

(21) Appl. No.: 18/645,832

(22) Filed: Apr. 25, 2024

(30) Foreign Application Priority Data
Jan. 24, 2024 (IN) 202441004839

(51) Int. Cl. G11B 27/34; G10L 15/26; G11B 27/031

(52) U.S. Cl. CPC G11B 27/34; G10L 15/26; G11B 27/031

(57) ABSTRACT

An integrated system for efficiently managing and reviewing multimodal media content in legal and document review contexts is presented. This system introduces synchronized, four-dimensional interface components that streamline the review of audio and video content. Features include the normalization and compression of media files for optimized playback, conversion of audio into searchable text, and a synchronized timeline view with audio waveforms and video thumbnails for precise navigation. Additionally, the system offers redaction capabilities, allowing for the selective removal of sensitive information from media content without compromising file integrity. The system offers a comprehensive solution for analyzing and managing multimedia content within eDiscovery tools.

### CROSS-REFERENCE TO RELATED APPLICATIONS

This application claims the benefit and priority of Indian Patent Application number 202441004839, filed on Jan. 24, 2024, which is hereby incorporated by reference herein, including all references and appendices cited therein.

### FIELD

The present disclosure pertains to the field of digital media management in legal and document review contexts, specifically focusing on an integrated system for the review, analysis, and selective redaction of multimodal (audio and video) content. It incorporates advanced features such as synchronized transcription, waveform and thumbnail timeline views, enhanced playback controls, and secure redaction capabilities, tailored for electronic discovery and document management applications.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for reviewing audio and video content in a document review and electronic discovery software platform. The method also includes normalizing and compressing audio and video files for playback with reduced bandwidth and latency requirements. The method also includes transcribing audio content of the files using a transcription service to make the content searchable. The method also includes displaying a timeline view associated with the audio and video content, including an audio waveform indicating spoken parts and a thumbnail view for video content. The method also includes providing playback controls for the audio and video content, including speed adjustment and autoplay features. The method also includes synchronizing playback of the audio and video content with the displayed timeline view and transcription. The method also includes facilitating review and analysis of the audio and video content within the document review and electronic discovery software platform. Other embodiments of this aspect include corresponding computer systems, apparatus, and computer programs recorded on one or more computer storage devices, each configured to perform the actions of the methods.

Implementations may include one or more of the following features. The method may include enabling a user to select portions of audio and video content for redaction based on timestamps or transcription text. The redaction process is synchronized with a timeline view and transcription of the audio and video content. The method may include replacing redacted portions with blank segments to prevent inference of the redacted content. The method may include adding a buffer period to the beginning and end of each redacted segment. Redacted sections are visually and audibly distinct from non-redacted sections. The method may include integrating video OCR and object detection features to enhance video analysis. Video ocr includes extracting textual content from video frames. Object detection includes identifying and classifying objects within the video content. The method may include providing a preview of redacted content before finalizing the redaction process. Implementations of the described techniques may include hardware, a method or process, or computer software on a computer-accessible medium.

One general aspect includes a system for reviewing and redacting audio and video content within an electronic discovery software platform a processor and memory for storing instructions, the processor executing the instructions to: normalize and compress audio and video file for playback; convert audio content of the audio and video file into searchable text; present a synchronized timeline view associated with the audio and video file; receive input from a user pertaining to speed adjustment and autoplay for the audio and video file; align playback with the synchronized timeline view and the searchable text; and present the synchronized timeline view and the searchable text of the audio and video file. Other embodiments of this aspect include corresponding computer systems, apparatus, and computer programs recorded on one or more computer storage devices, each configured to perform the actions of the methods.

Implementations may include one or more of the following features. The system may include a redaction module for selecting and redacting portions of content based on timestamps or transcription text. The redaction module synchronizes redaction with the timeline view and transcription. The redaction module replaces redacted portions with blank segments. The redaction module adds a buffer period to each redacted segment. The system configured to generate an output where redacted sections are distinct from non-redacted sections. The system may include video OCR and object detection capabilities for enhanced video analysis. The video OCR capability extracts textual content from video frames. The object detection capability identifies and classifies objects within video content. Implementations of the described techniques may include hardware, a method or process, or computer software on a computer-accessible medium.

One general aspect includes a method for redacting portions of audio and video content in a document review and eDiscovery software platform. The method also includes allowing a user to select portions of audio and video content for redaction based on timestamps or transcription text. The method also includes synchronizing the redaction process with a timeline view and transcription of the audio and video content, enabling precise selection of redaction points. The method also includes permanently removing the selected portions from the audio and video content and replacing them with blank segments. The method also includes adding a buffer period to the beginning and end of each redacted segment to prevent inference of the redacted content. The method also includes generating a native output of the redacted content where redacted sections are visually and audibly distinct from non-redacted sections. The method also includes generating a preview or the redacted native output before production workflow is triggered within the eDiscovery platform. Other embodiments of this aspect include corresponding computer systems, apparatus, and computer programs recorded on one or more computer storage devices, each configured to perform the actions of the methods.

### BRIEF DESCRIPTION OF THE DRAWINGS

Exemplary embodiments are illustrated by way of example and not limited by the figures of the accompanying drawings, in which references indicate similar elements.

FIG. 1 illustrates an example computing architecture of a system of the present disclosure.

FIG. 2 is an example flowchart of a method that can be executed by an example system.

FIG. 3 is an example flowchart of a method that can be executed by an example system.

FIG. 4 illustrates a flowchart that outlines a comprehensive workflow within an eDiscovery platform, detailing the steps from initial login to the final production of documents.

FIG. 5 illustrates an interactive graphical user interface (GUI) in a software application used for analyzing and redacting audiovisual media.

FIG. 6 illustrates a GUI configured similarly, albeit for audio media.

FIG. 7, illustrates a GUIs for a software system designed for the integration and analysis of multimedia content within an eDiscovery platform.

FIGS. 8 and 9 collectively illustrate an aspect of the multimedia analysis system, particularly focusing on a user interface component designed for the synchronized review by search and redact of multimedia content within an eDiscovery platform.

FIG. 10 depicts an interface module for previewing redacted production outputs within a media viewer.

FIGS. 11-13 collectively illustrate GUIs of a multifaceted redaction tool within an eDiscovery platform, demonstrating the system's selective content redaction capabilities for multimedia files.

FIG. 14 is a diagrammatic representation of an example machine in the form of a computer system 1, within which a set of instructions for causing the machine to perform any one or more of the methodologies discussed herein may be executed.

### DETAILED DESCRIPTION OF EXAMPLE EMBODIMENTS

### Overview

The present disclosure pertains to an advanced system for multimodal media management, specifically engineered to enhance the review, analysis, and redaction of audio and video content in legal and document review environments, notably within e-discovery applications. It introduces a synchronized, four-dimensional interface comprising audio and/or video playback, thumbnail to video thumbnails, Waveform to audio waveform, and transcript components, seamlessly integrating these elements to provide a comprehensive and efficient review experience.

One challenge addressed by the system is the synchronization of these diverse components to enable legal professionals to navigate effortlessly through media files. This synchronization allows for alignment of all components when a user selects a particular timeline point in any one dimension, thus maintaining continuity and context during the review process. The system significantly improves the efficiency, accuracy, and depth of media file analysis, making it an invaluable tool in legal proceedings.

In terms of user interaction, the system offers an interactive timeline visualization, facilitating chronological navigation and efficient access to specific audio and/or video segments. Users can navigate through the audio/video recordings using various controls like player slide seek, redaction timeframe slider, audio waveform, video thumbnails and transcript text. This multi-faceted approach ensures that users have a holistic and nuanced understanding of the media content, enhancing their ability to conduct effective reviews.

One aspect of this system is its capability to handle extended duration recordings. The synchronized components allow users to efficiently navigate through lengthy audio and video files, crucial for analyzing long interviews or surveillance footage. The waveform visualization provides additional insights into the audio content, like pauses, tone changes, or overlapping speech, aiding in a more detailed content analysis.

Moreover, the system includes robust redaction features. It streamlines the process of redacting sensitive information (using viewers redaction tool by using timeframe or selecting block/part of the transcript text or find and redact) within audio and video content, ensuring precise identification and redaction of such information. The synchronization aspect allows Quality Control (QC) practitioners to quickly jump to specific redacted timeframes, thus optimizing the QC review process and enhancing the precision of redactions.

The system can also include the incorporation of Video OCR and object detection capabilities. These features enable tying multiple insights of a video, such as OCR screen content, brand logos, and other objects, to their respective timestamps. This comprehensive approach provides legal professionals with a more integrated and context-rich analysis of the evidence.

In summary, the present technology represents a significant advancement in eDiscovery tools, offering a unified, synchronized system that enhances the review, analysis, and redaction of multimedia content in legal contexts. It provides a user-friendly, efficient, and precise tool for managing and analyzing audio and video evidence, thereby facilitating more effective legal strategies and outcomes.

### EXAMPLE EMBODIMENTS

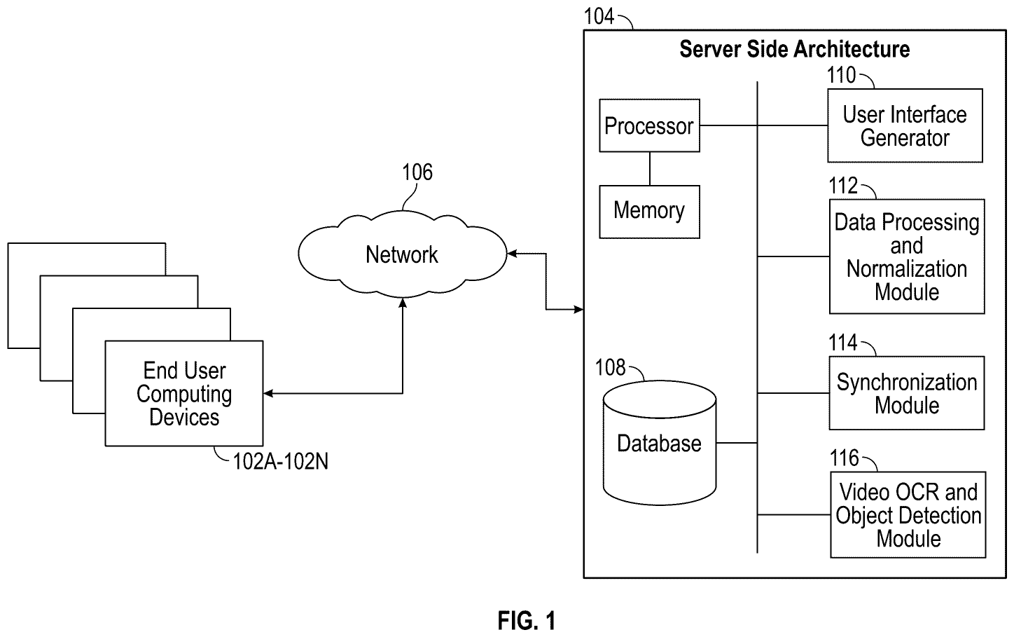

FIG. 1 illustrates an example computing architecture of a system of the present disclosure. In more detail, an architecture for implementing the present disclosure could include client-side computing devices 102A-102N for end users, a server-side architecture 104 that could be cloud-based or localized, and a network 106 providing communicative coupling therebetween. The network could include any public or private network. The architecture could include a database 108 for storing original and redacted media, as well as any intermediate data. This storage can be local (on client devices or on-premises servers) or cloud-based, depending on the system design and data security requirements. The architecture could also include a security infrastructure, which includes appropriate security software and protocols to protect sensitive data during the redaction process and in storage, such as encryption tools, firewalls, and secure data transmission methods.

In general, the server-side architecture includes the following components or services. To be sure, this description is not intended to limiting and is provided for example purposes only. Another server-side architecture that provides similar features can be used. In general, the server implements at least an e-discovery platform that is configured to provide the multimodal media features disclosed herein.

The architecture of the described multimodal media management and redaction system, particularly in the eDiscovery context, is composed of several high-level computing elements. Firstly, it features a User Interface Generator (UI) 110 that seamlessly integrates video playback, thumbnails, audio waveform, and transcript text for efficient media review. This interface is designed for intuitive navigation and ensures synchronized interaction among the different media dimensions.

The system also includes a data processing and normalization module 112 responsible for optimizing audio and video files for playback. This includes compressing and normalizing these files to reduce bandwidth and latency, ensuring smooth and efficient media streaming. The system is also integrated with a transcription service, such as AWS Transcribe (any transcription service can be utilized), which converts audio tracks into searchable text, enhancing the capability to navigate and analyze audio content.

In some embodiments, the system can generate transcript text. Production output of the transcribed text can include two general forms, which include, but are not limited to, native or include text. The system can produce text output by removing redacted content from extracted text such as transcripts, video OCR, and/or object detection-just to name a few.

The process of transcribing audio and video files makes the content searchable and more accessible for review. When the system generates a native transcript, it provides a textual representation of the spoken content within these files. This transcript becomes a part of the system's capability to synchronize playback of the audio and video content with a timeline view, including audio waveforms and thumbnail views for video content, thus facilitating a comprehensive review and analysis process.

The native transcript text allows users to efficiently navigate through the audio and video recordings, identify relevant sections based on the transcription, and select portions for redaction based on this text. The native transcript enables precise and informed selection of content for redaction, ensuring that sensitive information can be accurately identified and removed, while also providing a context-rich environment for legal review and analysis tasks.

Another component is the synchronization module 114, which maintains consistency across the different media dimensions. Actions in one dimension, such as selecting a point in the video timeline, are reflected in the thumbnails, waveform, and transcript, ensuring a cohesive review process.

For media control, the architecture includes advanced playback features. These controls allow users to adjust the speed, utilize autoplay, and navigate through the content with case. There is also an integrated redaction tool, enabling users to precisely select and redact specific parts of the audio and video content. This tool ensures the permanence of redactions and includes features to add buffers around redacted segments for additional security.

The system is supported by a robust backend database infrastructure 108. The server-side architecture 104 handles processing and logic, while the database stores important data like metadata, user actions, synchronization information, and details of redactions, ensuring data consistency and reliability. Security and compliance are paramount in this architecture, given the sensitivity of legal documents. The system incorporates strong security protocols and complies with legal standards to safeguard data integrity and confidentiality.

The architecture can include a video OCR and object detection module 116, provides advanced analytical capabilities. Additionally, cloud integration is another aspect, leveraging cloud services for scalability, data storage, and computational power, especially for tasks like video processing and transcription. Overall, this architecture includes a blend of user-centric design, efficient data processing, synchronized multimedia handling, advanced control features, and a backend support system, all aligned with stringent security and compliance requirements.

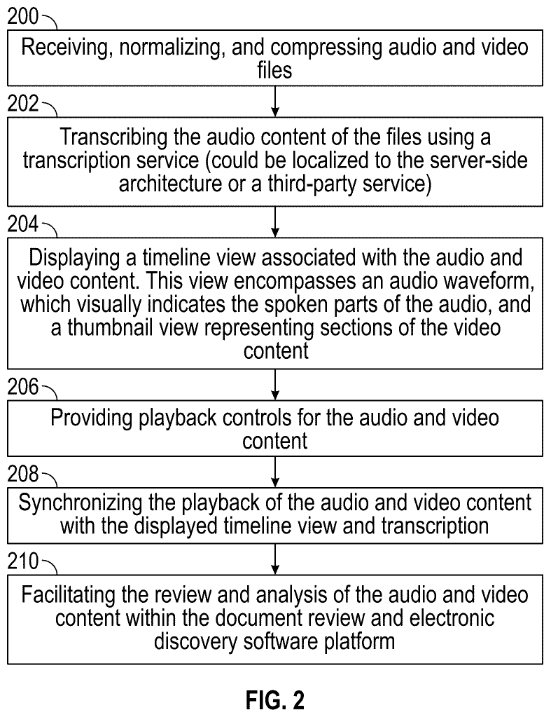

Referring now to FIGS. 1 and 2 collectively, in an example embodiment, the present disclosure can be directed to a method that can be executed by the server-side architecture 104. In this step 200, a method for reviewing audio and video content within the server-side architecture 104 begins by receiving, normalizing, and compressing audio and video files. This initial process is designed to enable playback with reduced bandwidth and latency requirements, thereby improving the efficiency and speed of the review process.

Continuing to step 202, the method includes transcribing the audio content of the files using a transcription service (could be localized to the server-side architecture or a third-party service). This transcription converts spoken words into searchable text, allowing users to locate specific content quickly within the audio and video files. In step 204, the method involves displaying a timeline view associated with the audio and video content. This view encompasses an audio waveform, which visually indicates the spoken parts of the audio, and a thumbnail view representing sections of the video content. This visual representation facilitates the identification of relevant sections within the media files.

Proceeding to step 206, the method provides playback controls for the audio and video content. These controls include features for speed adjustment, allowing reviewers to listen to the audio at varying speeds, and autoplay, which enables continuous playback without manual intervention. In step 208, the method includes synchronizing the playback of the audio and video content with the displayed timeline view and transcription. This synchronization ensures that the visual timeline and the transcribed text accurately reflect the content being played back, allowing for precise review and referencing.

Finally, in step 210, the method facilitates the review and analysis of the audio and video content within the document review and electronic discovery software platform (server-side architecture 104). This comprehensive approach allows reviewers to interact with multimedia content in a streamlined and integrated manner, enhancing the overall effectiveness and thoroughness of the document review process.

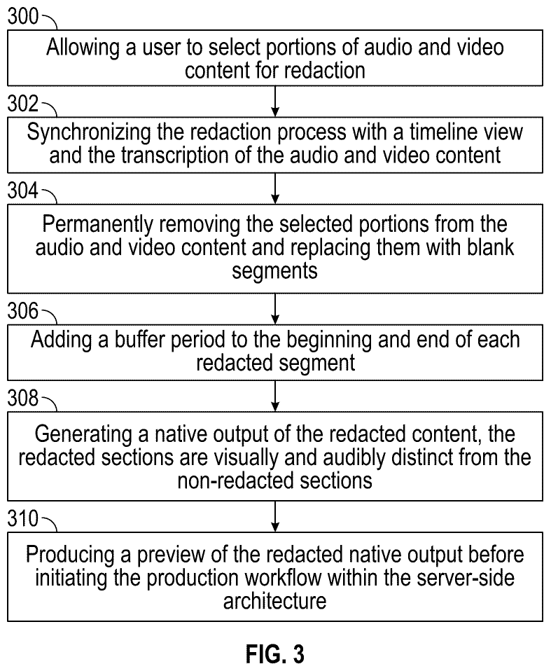

FIG. 3 is an example embodiment that is directed to a method that can be executed by an example system. In this step 300, the method initiates a redaction process within a document review and electronic discovery software platform (server-side architecture 104) by allowing a user to select portions of audio and video content for redaction. This selection can be based on specific timestamps or corresponding transcription text, enabling the user to pinpoint the exact content requiring confidentiality or privacy measures.

Moving to step 302, the method includes synchronizing the redaction process with a timeline view and the transcription of the audio and video content. This synchronization ensures precise selection of redaction points, facilitating accuracy and consistency in the redaction of multimedia content. In step 304, the method executes the redaction by permanently removing the selected portions from the audio and video content and replacing them with blank segments. This ensures the redacted information cannot be recovered or accessed post-redaction.

Progressing to step 306 (optional), the method enhances the redaction by adding a buffer period to the beginning and end of each redacted segment. This buffer can be inserted to prevent any potential inference or deduction of the redacted content, thereby maintaining the integrity of the redaction.

In step 308, the method generates a native output of the redacted content. In this output, the redacted sections are visually and audibly distinct from the non-redacted sections, making it clear to reviewers and other stakeholders which portions of the content have been altered.

Finally, in step 310, the method produces a preview of the redacted native output before initiating the production workflow within the server-side architecture 104. This preview allows for final checks and validations, ensuring the redactions meet the required standards and specifications before the content is utilized in subsequent legal or review processes.

### Redaction Embodiments

In the multimodal media management system designed for legal e-discovery applications, the redaction process is structured to ensure precision and security, particularly for audio and video content. Initially, the process begins with the user's interaction, where they identify and select the specific segment of the media file that requires redaction. This selection is typically made by reviewing the content and using the system's user interface. Users can choose the start and end points of the redaction based on timestamps, transcript text, or through visual identification within the video or audio waveform. Once the user makes a selection, synchronized changes occur in all media components, with visual indicators or markers indicating the redacted areas and the reason for the redaction.

Once the user makes a selection, this input is processed by the server-side architecture 104. The server receives the command, which includes detailed information about the timestamps or transcript text that mark the boundaries of the intended redaction. Following this, the system executes the redaction on the chosen segment. This step involves permanently removing the selected portion from the audio or video file. In the case of video, it means excising both the audio and visual elements for the duration of the selected timeframe, whereas for audio files, it involves cutting out the specified segment of the audio track. Other embodiments allow for selective or partial redaction as set forth infra.

The next step is the insertion of blank segments in place of the redacted content. This replacement with blank or silent segments maintains the continuity of the media file's timeline, ensuring that the duration of the file remains unchanged while making the redacted content inaccessible and irretrievable. To further enhance the security of the redacted segment, the system often adds a buffer period at both the beginning and end of each redacted segment. This addition effectively extends the redaction slightly beyond the selected points, safeguarding against the possibility of leaving any contextually revealing content unredacted.

The system then finalizes the modifications, creating a new version of the media file where the redactions are permanent and secure. The output file clearly delineates the redacted sections, making them visually and audibly distinct from the non-redacted parts. This differentiation might include visual indicators or markers in the video or audio timeline to signify the redacted areas. Examples can include periodic or continuous beeps or other auditory output.

Another aspect of this process is the quality control (QC) phase, where QC practitioners are provided with tools to review the redactions. This feature allows them to quickly navigate to, inspect, and validate the redacted segments, ensuring accurate application and that no sensitive information remains in the media file. Throughout the redaction process, the system upholds standards of security and compliance, crucial in the handling of sensitive legal documents. This comprehensive approach to redaction in the e-discovery context reflects the system's commitment to precision, security, and the integrity of the legal review process.

### Use Case Complete Redaction

In a use case illustrating the utilization of the multimodal media viewer and redaction feature, consider a legal team working on a high-profile corporate litigation case. While video is described, audio can be likewise processed. They receive several hours of video recordings from corporate meetings, potentially containing critical information for the case. However, these recordings also include sensitive discussions and personal data that must be redacted before submission as part of the discovery process.

The legal team uploads the video into the e-discovery platform equipped with the multimodal media management system. Using the system's synchronized interface, they start reviewing the video. The interface presents the video playback alongside thumbnails, an audio waveform, and a transcript. This synchronization allows the team to navigate the video efficiently, correlating spoken words in the transcript with the video and audio content.

As the team identifies a segment in the video where sensitive information is discussed, they use the redaction tool within the system. By selecting the start and end points on the transcript or directly on the video timeline, they mark this segment for redaction. The system processes this input and permanently removes the specified segment from both the audio and video tracks. This segment is replaced with blank audio and a black screen in the video (the black screen can also overlay a redaction reason like “Confidential”), ensuring the information is irretrievable.

Additionally, the system adds a small buffer period before and after the redacted segment, further securing the redaction by ensuring that no partial information is left. The final output displays the redacted sections distinctly, with markers indicating where redactions have occurred. This allows for a final review by the QC team, ensuring no sensitive information has been missed and that all redactions are correctly applied.

Throughout this process, the team is able to efficiently navigate, review, and redact sensitive portions of the video, making the system an invaluable tool in handling and preparing complex legal documents while ensuring compliance and confidentiality.

### Use Case Selective Content Video Redaction

In this use case, the legal team encounters a video where a child is speaking. The content of the child's speech is relevant to the case, but there is a need to protect the child's identity. The team decides to redact the child's face from the video to maintain confidentiality. Using the system's redaction tool, they can specify the segments of the video where the child appears and initiate a redaction process that only affects the visual component. The system processes this command and replaces the video segments featuring the child's face with a blank screen or an appropriate placeholder image.

During this process, the audio track of the video, which contains the child's voice and other relevant sounds, remains untouched. This selective redaction allows the legal team to present the audio evidence in court while adhering to privacy and ethical standards regarding the protection of a minor's identity. The system's capability to differentiate between audio and visual components and apply redactions accordingly showcases its adaptability to complex legal requirements.

This feature is particularly valuable in legal scenarios where audio evidence is crucial, but visual anonymity is required. The ability to customize redactions at this level is advantageous in sensitive cases and provides alignment with legal standards and ethical considerations in media handling within the legal domain.

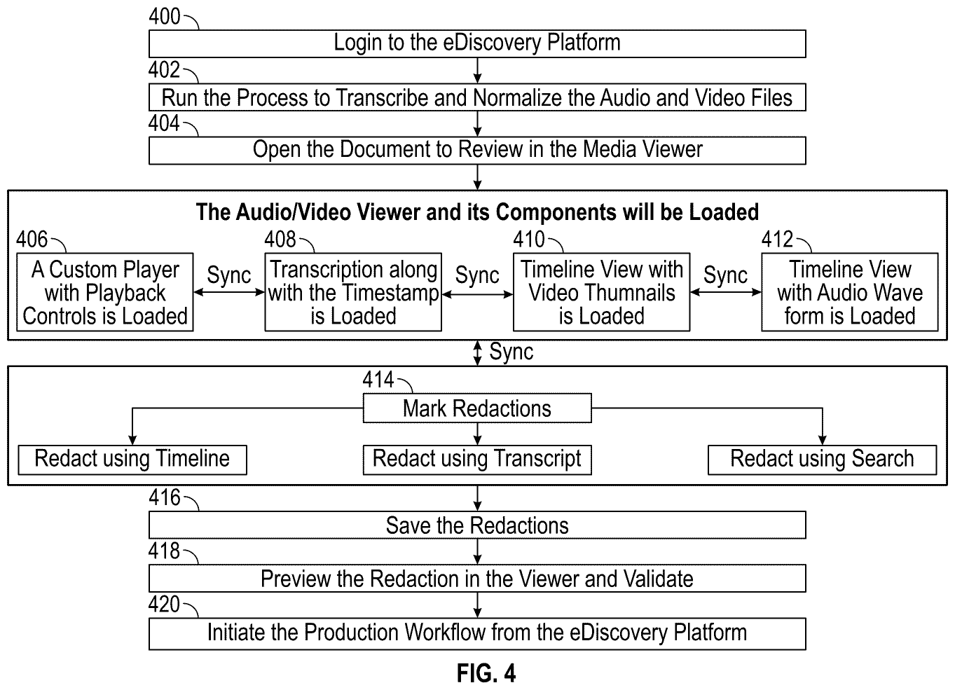

FIG. 4 illustrates a flowchart that outlines a workflow within an eDiscovery platform, detailing the steps from initial login to the final production of documents. It begins with the user accessing the eDiscovery platform (server-side architecture 104), followed by receiving, transcribing, and normalizing audio and video files. After loading the media into the viewer, the user synchronizes various components, including a custom player with playback controls, a transcription with timestamps, and timelines with video thumbnails and audio waveforms. Redactions are then marked using the timeline, transcript, or a search function. These redactions are saved, previewed for accuracy, and validated. The process concludes with the initiation of a production workflow on the eDiscovery platform, preparing the documents for their final use case.

In step 400, the user logs into the eDiscovery platform, and in step 402 the users initiates a process to upload, transcribe, and normalize audio and video files. After this process, the user opens a document to review in the media viewer in step 404. Subsequently, the audio/video viewer and its components are loaded for use in step 406.

The user can then select to synchronize (sync) a custom player with playback controls in 406, the transcription alongside its timestamp in step 408, the timeline view with video thumbnails in 410, and the timeline view with audio waveforms in step 412.

With the synchronization completed, the user proceeds to mark redactions in the media in step 414. In some embodiments, there are three methods provided for redaction: (1) redacting using the timeline; (2) redacting using the transcript, and (3) redacting using a search function. Once the redactions are marked, the user saves them at step 416. The user then previews the redaction in the viewer and validates it to ensure accuracy in step 418. Finally, the user initiates the production workflow from the eDiscovery platform, which is the step 420 where the redacted files are compiled and organized for legal proceedings or other relevant purposes.

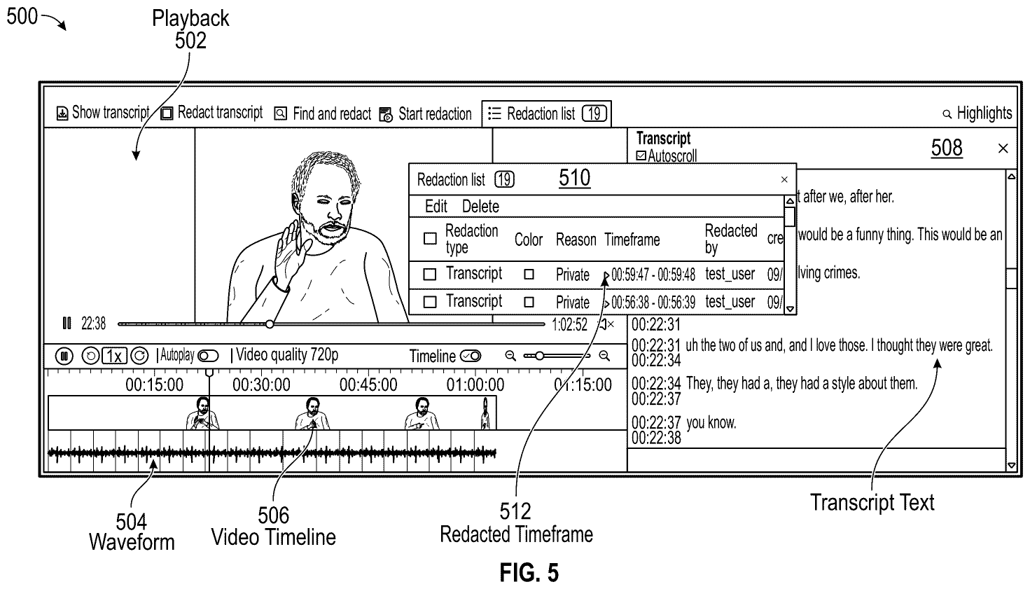

FIG. 5 illustrates an interactive graphical user interface (GUI) 500 in a software application used for analyzing and redacting audiovisual media. The GUI depicts a module within the server-side architecture 104 where an audio/video playback interface 502 is present, equipped with functionalities for playback control and timeline navigation. A waveform visualization 504 of the audio component is displayed beneath the video, providing a visual representation of the audio signal's intensity over time along with a video timeline 506. Alongside the playback and waveform components, a synchronized transcript pane 508 allows users to visually track the spoken words. The system is capable of marking and listing redactions 510, with each redaction entry specifying its type, color, reason, and the corresponding timeframe within the media file. Redaction timeframes 512 are also shown. It will be understood that the layout of any of the GUIs can be different than what is illustrated.

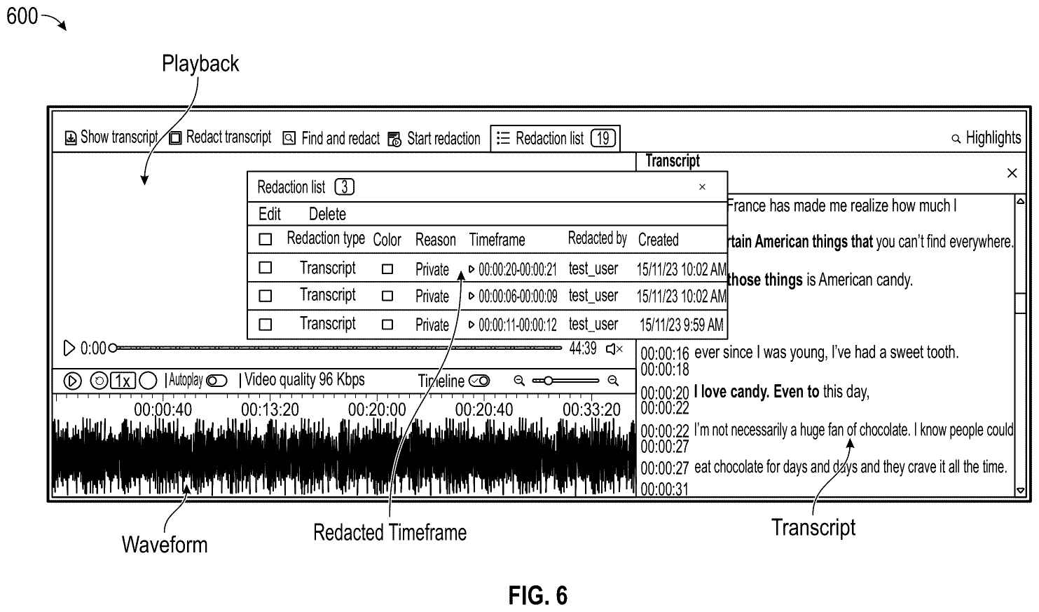

FIG. 6 illustrates a GUI 600 configured similarly, albeit for audio media. It includes a playback control, a detailed waveform visualization, and a synchronized transcript pane. This interface also allows for the marking of redactions, which are listed with details including the redaction type, reason, and specific timestamps.

Both GUIs (5 and 6) are designed to integrate media playback with transcript synchronization, enabling users to efficiently review and execute redactions within the media timeline. This technical solution addresses the problem of manually correlating transcribed text with specific moments in audiovisual media, providing a streamlined approach to content redaction that is critical in legal and privacy-sensitive environments. The integration of these functionalities into a single GUI facilitates an improved workflow for users performing eDiscovery tasks.

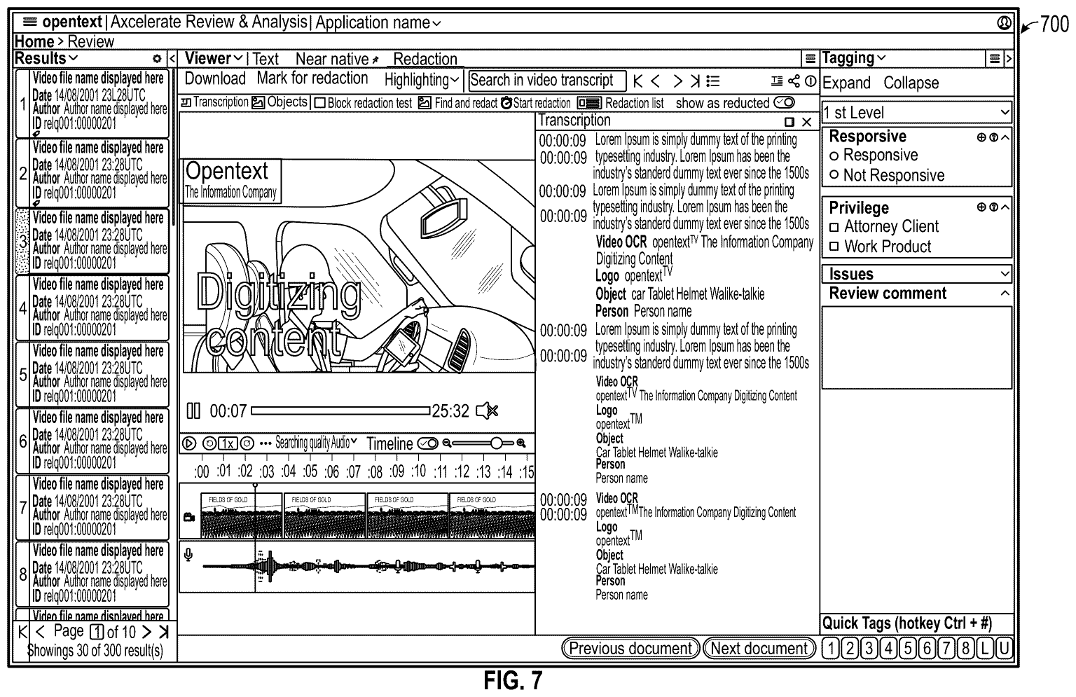

Referring now to FIG. 7, a GUI 700 illustrates a software system designed for the integration and analysis of multimedia content within an eDiscovery platform. The system utilizes advanced algorithms, including Video Optical Character Recognition (VOCR) and object detection, to extract textual and visual data from video content. This extracted information, including brand logos, textual overlays, and discernible objects within the video, is then correlated with specific timestamps, creating a searchable index tied to the video's timeline.

The system's interface presents a video document where AI (artificial intelligence or the like) algorithms have extracted specific speech text, visual screen labels, and visual objects, which are all meticulously tied to the same timestamp. This feature allows legal professionals to conduct comprehensive searches across the indexed data by inputting keywords or terms, enabling them to identify relevant evidence quickly. The interface also offers functionalities for highlighting and redacting sensitive information directly within the platform, thereby maintaining the integrity of the legal review process.

The user interface further includes a side panel where the transcript and extracted data are displayed alongside the video playback. The system's ability to tie multiple insights to their respective contexts within the video content represents a technical advancement in eDiscovery, allowing for a collective and comprehensive analysis of evidence. This unified approach ensures that all related insights-whether they are spoken words, visual text, or objects—are highlighted and accessible, streamlining the review process and enhancing the efficiency of legal evidence analysis within a single eDiscovery platform.

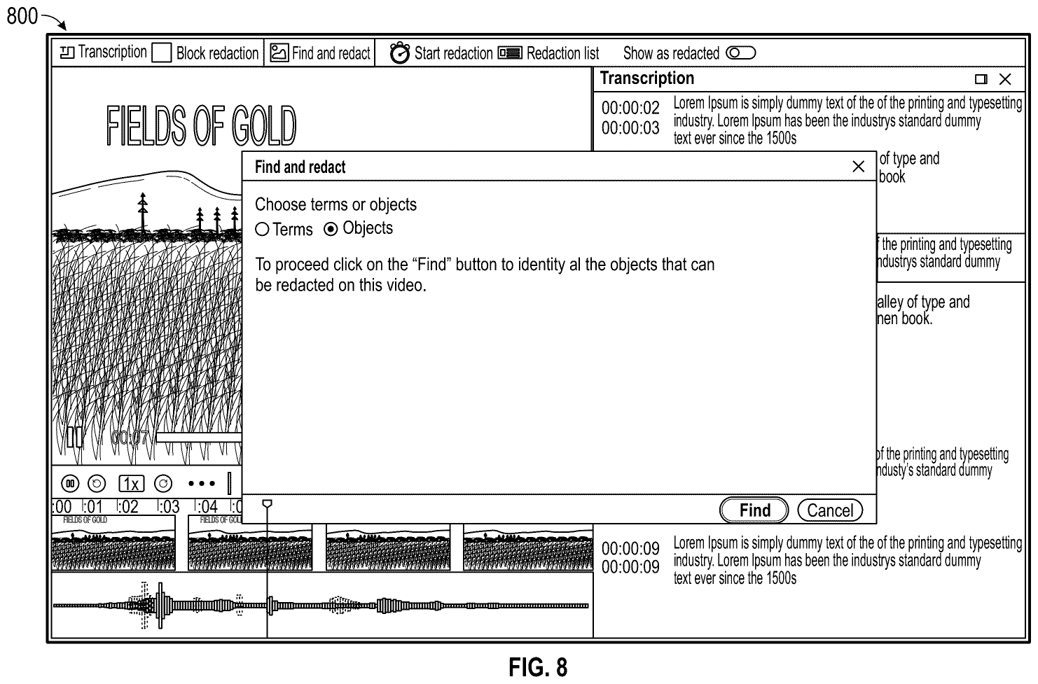

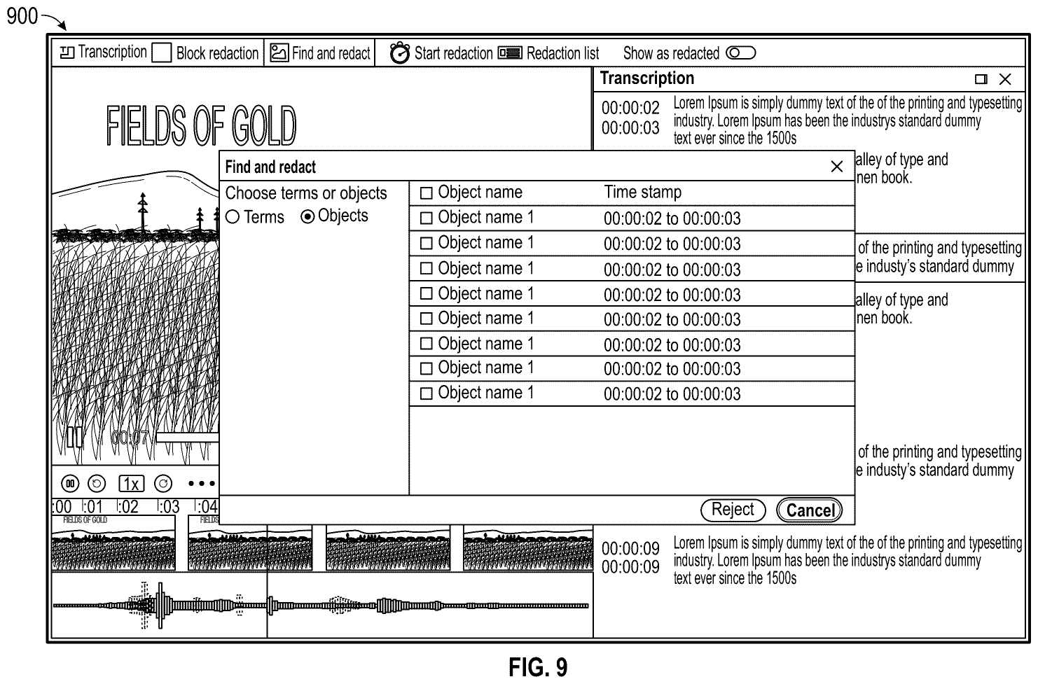

FIGS. 8 and 9 collectively illustrate graphical user interfaces (GUI) 800 and 900 that allow a user to which are used for find, search, and/or redact operations that can be performed on transcripts, videos, OCR, or objects detected. In GUI 800 the interface can allow a user to select whether they wish to search to for terms or objects for redact. In this instance, objects have been selected and this allows the user to have the system identify objects in the video that can be redacted. FIG. 9 shows the objects identified and their respective positions in the timeline of the video by timestamp. The user can select whichever objects they desire to redact from the GUI 900.

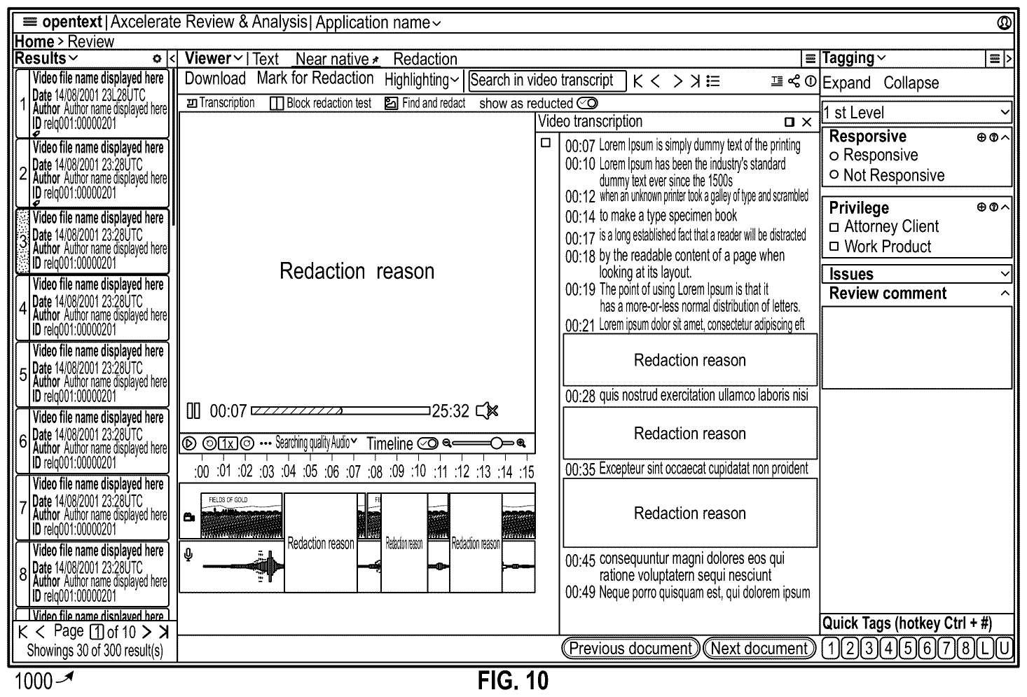

FIG. 10 depicts a feature of a multimedia content analysis system, more specifically, a user interface 1000 for previewing redacted production outputs within a media viewer. The module includes a video playback window that integrates with a transcription and redaction feature. This tool allows users to select specific objects or terms for redaction, which are then listed with corresponding timestamps in a side pane.

This feature of the server-side architecture allows users to preview redacted versions of video and audio documents within the media viewer prior to generating the native production output. The interface includes an interactive timeline with visual indicators denoting the locations of redactions. When a redaction is selected, the system displays the precise segment within the playback window, providing a quality control measure to ensure the accuracy and appropriateness of redactions before finalizing the output.

This capability represents a technical solution that enhances the overall functionality of cDiscovery platforms by allowing for the precise and verifiable redaction of multimedia content. It ensures that sensitive information is obscured as intended in the final production output, thereby maintaining the integrity of the legal discovery process. The interface's design, which includes playback controls, a timestamp-linked transcript, and a redaction list, allows for an efficient and accurate review and editing process within a single software environment.

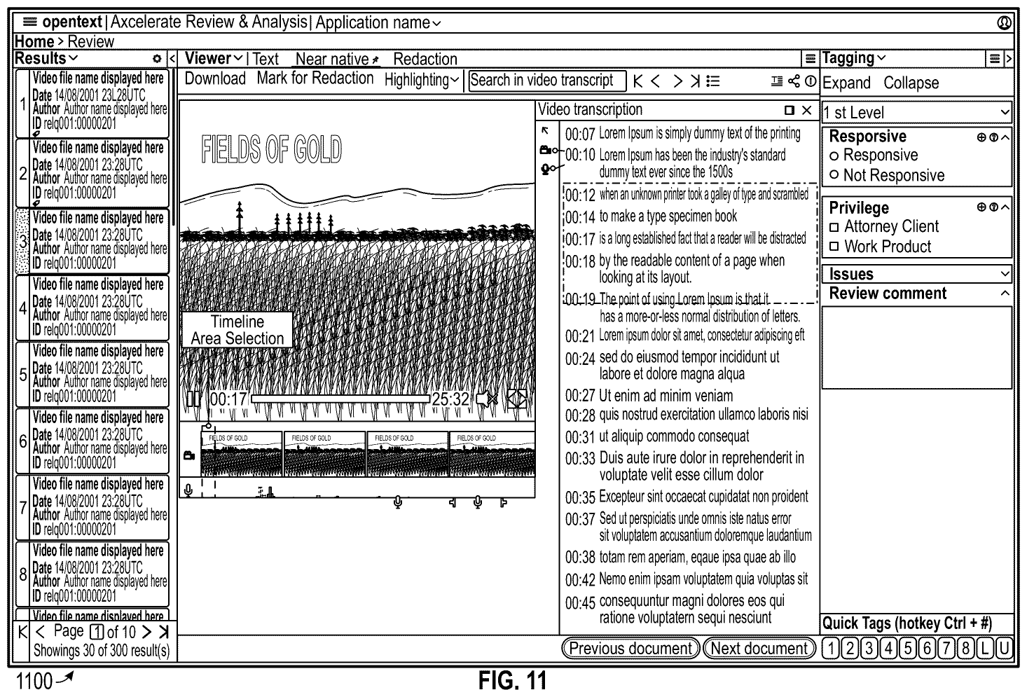

FIG. 11-13 collectively illustrate GUIs of a multifaceted redaction tool within an eDiscovery platform, demonstrating the system's selective content redaction capabilities for multimedia files. In FIG. 11, an active video transcription feature illustrates, highlighting the ‘Redaction Reason’ feature that can be replaced with a reason such as sensitive, privileged, and so forth This allows a reviewer to annotate specific segments of the media file with reasons for redaction, providing a clear audit trail and rationale for each redaction made. The interface permits selective redaction scopes, such as redacting only audio, only video, or both, enhancing the precision and flexibility of the redaction process.

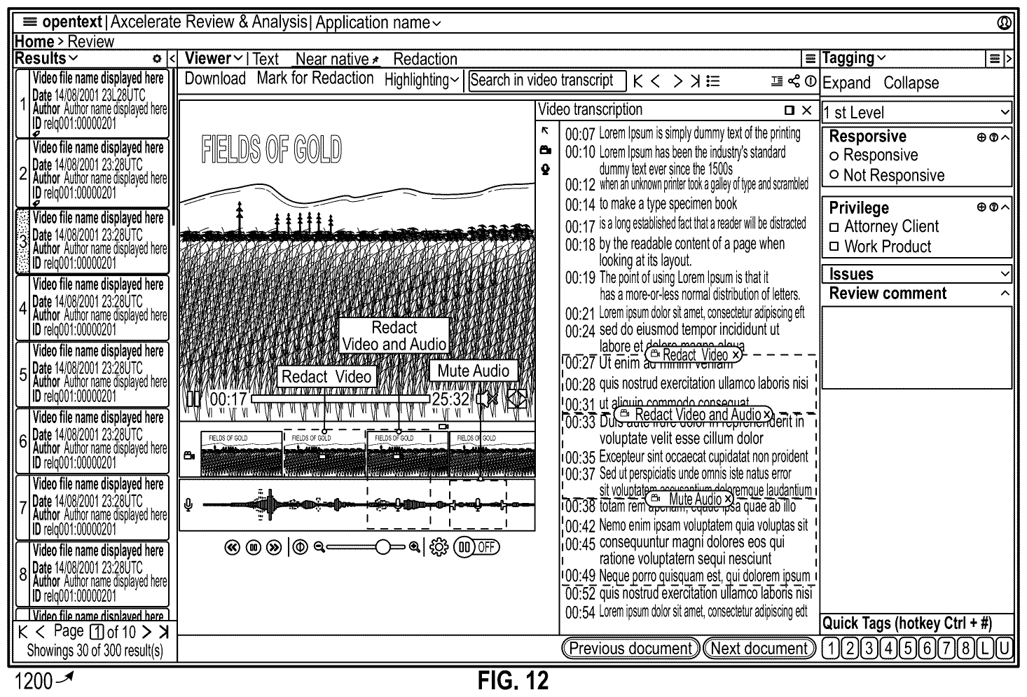

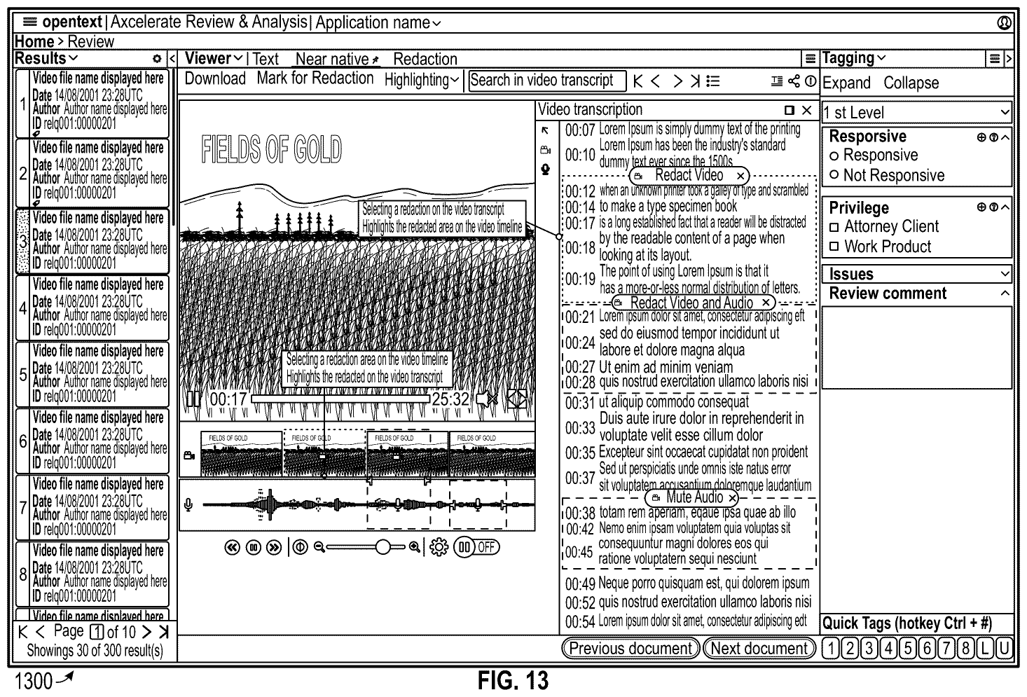

FIGS. 12 and 13 illustrate graphically, visual feedback of the redaction process. Highlighted areas in the synchronized timeline and transcript indicate where redactions have been applied within the media file. This visual cueing system allows users to quickly identify and review all instances of redaction, ensuring no section requiring redaction is overlooked and that each redaction is appropriately justified and documented.

The highlighted portions within the transcript correspond with the redacted segments in the media, signaling to the user where the content has been redacted. These highlights serve as a visual confirmation, enabling reviewers to ensure the correct portions of the media are redacted in accordance with the rationale provided, thereby maintaining the integrity of the process and the confidentiality of the information. The user can select what is to be redacted either from the timeline or the video/audio itself. The user can use the tagging pane to provide additional redaction details. In FIG. 12, this illustrates that the user can selectively redact video only, audio and video, or only audio through a mute feature. Again, the sections that were redacted are highlighted in the adjacent video transcript pane. FIG. 13 further illustrates that selecting a segment of the video highlights a corresponding area of the video transcription, and vice versa.

A key feature of this system is its ability to enable users to conduct redactions directly from the video timeline or the accompanying transcript. This functionality is not just a convenience but ensures the confidentiality and integrity of the information being handled. When reviewing multimedia content, legal professionals often encounter sensitive or privileged information that must be redacted before the content can be used in a legal setting or shared with opposing counsel. The unique aspect of this system is its synchronized interface, where the video timeline and the transcript are displayed side-by-side. This design allows users to easily navigate through the multimedia content, enhancing the review process's efficiency and accuracy.

Redacting directly from the video timeline is an intuitive process; users can visually identify sensitive segments within the video content and select them for redaction with precision. This method is particularly useful when the sensitive information is visual-such as a document appearing on screen or a person's face that needs to be anonymized. The system processes the redaction by permanently removing the selected segment and replacing it with a blank or obscured segment, ensuring that the sensitive content is irretrievable.

Alternatively, redacting from the transcript allows users to identify sensitive information through the text of the spoken content. This method is advantageous for quickly locating and redacting specific dialogue or audio information without having to listen to the entire audio track. Once a segment is identified in the transcript for redaction, the system synchronizes this action with the corresponding segment in the audio and video tracks, ensuring that the information is redacted across all modalities.

The dual capability of redacting from both the video timeline and the transcript ensures comprehensive coverage in the redaction process, accommodating different types of sensitive information—visual, spoken, or both. Furthermore, this approach allows for a high level of precision in the redaction process, as users can pinpoint the exact moments that require editing based on both visual cues and textual content.

Moreover, the system enhances the review and redaction process by providing features such as the addition of buffer periods to redacted segments and the ability to mark redacted sections as visually and audibly distinct from non-redacted content. These features further ensure that redacted content is securely and effectively anonymized, meeting the stringent requirements of legal confidentiality and data protection.

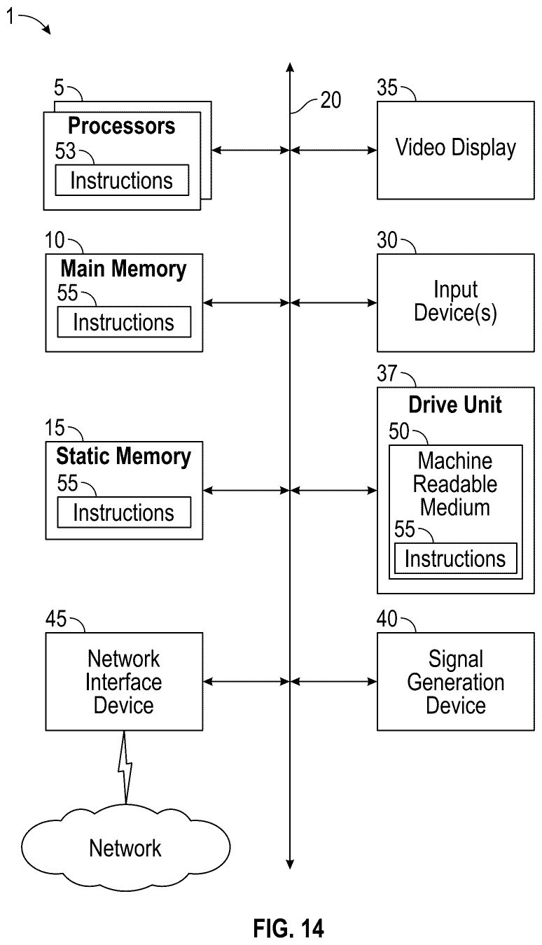

FIG. 14 is a diagrammatic representation of an example machine in the form of a computer system 1, within which a set of instructions for causing the machine to perform any one or more of the methodologies discussed herein may be executed. The system can be used to control any one or more of the components disclosed above.

In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

Where appropriate, the functions described herein can be performed in one or more of hardware, software, firmware, digital components, or analog components. For example, the encoding and or decoding systems can be embodied as one or more application specific integrated circuits (ASICs) or microcontrollers that can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

The terminology used herein is for the purpose of describing particular embodiments only and is not intended to be necessarily limiting of the disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In this description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

What is claimed is:

1. A method for reviewing audio and video content in a document review and electronic discovery software platform, the method comprising:
normalizing and compressing audio and video files for playback with reduced bandwidth and latency requirements;
transcribing audio content of the files using a transcription service to make the content searchable;
displaying a timeline view associated with the audio and video content, including an audio waveform indicating spoken parts and a thumbnail view for video content;
providing playback controls for the audio and video content, including speed adjustment and autoplay features;
synchronizing playback of the audio and video content with the displayed timeline view and transcription; and
facilitating review and analysis of the audio and video content within the document review and electronic discovery software platform.

2. The method of claim 1, further comprising enabling a user to select portions of audio and video content for redaction based on timestamps or transcription text.

3. The method of claim 2, wherein the redaction process is synchronized with a timeline view and transcription of the audio and video content.

4. The method of claim 3, further comprising replacing redacted portions with blank segments to prevent inference of the redacted content.

5. The method of claim 4, further comprising adding a buffer period to the beginning and end of each redacted segment.

6. The method of claim 5, further comprising generating an output of the redacted content wherein redacted sections are visually and audibly distinct from non-redacted sections.

7. The method of claim 1, further comprising integrating video OCR and object detection features to enhance video analysis.

8. The method of claim 7, wherein video OCR includes extracting textual content from video frames.

9. The method of claim 7, wherein object detection includes identifying and classifying objects within the video content.

10. The method of claim 1, further comprising providing a preview of redacted content before finalizing the redaction process.

11. A system for reviewing and redacting audio and video content within an electronic discovery software platform, comprising:
a processor and memory for storing instructions, the processor executing the instructions to:
normalize and compress audio and video file for playback;
convert audio content of the audio and video file into searchable text;
present a synchronized timeline view associated with the audio and video file;
receive input from a user pertaining to speed adjustment and autoplay for the audio and video file;
align playback with the synchronized timeline view and the searchable text; and
present the synchronized timeline view and the searchable text of the audio and video file.

12. The system of claim 11, further comprising a redaction module for selecting and redacting portions of content based on timestamps or transcription text.

13. The system of claim 12, wherein the redaction module synchronizes redaction with the timeline view and transcription.

14. The system of claim 13, wherein the redaction module replaces redacted portions with blank segments.

15. The system of claim 14, wherein the redaction module adds a buffer period to each redacted segment.

16. The system of claim 15, configured to generate an output where redacted sections are distinct from non-redacted sections.

17. The system of claim 11, further comprising video OCR and object detection capabilities for enhanced video analysis.

18. The system of claim 17, wherein the video OCR capability extracts textual content from video frames.

19. The system of claim 17, wherein the object detection capability identifies and classifies objects within video content.

20. A method for redacting portions of audio and video content in a document review and electronic discovery software platform, the method comprising:
allowing a user to select portions of audio and video content for redaction based on timestamps or transcription text;
synchronizing the redaction process with a timeline view and transcription of the audio and video content, enabling precise selection of redaction points;
permanently removing the selected portions from the audio and video content and replacing them with blank segments;
adding a buffer period to the beginning and end of each redacted segment to prevent inference of the redacted content;
generating a native output of the redacted content wherein redacted sections are visually and audibly distinct from non-redacted sections; and
generating a preview or the redacted native output before production workflow is triggered within the eDiscovery platform.
